(19) United States
(12) Patent Application Publication
(10) Pub. No.: US 2016/0325265 A1
(43) Pub. Date: Nov. 10, 2016

(54) METHOD FOR PRODUCING POLYAMIDES BY MEANS OF A SPRAY NOZZLE ARRANGEMENT FOR THE COLLISION OF SPRAY JETS

(71) Applicant: BASF SE, Ludwigshafen (DE)

(72) Inventors: NING ZHU, Mannheim (DE); Rainer OSTERMANN, Lembrunch (DE); Heinrich SACK, Germany (DE); Alexander GOETZ, Meckenheim (DE); Achim STAMMER, Freinshim (DE); Dirk SIMON, Mannheim (DE)

(73) Assignee: BASF SE, Ludwigshafen (DE)

(21) Appl. No.: 15/104,728

(22) PCT Filed: Dec. 17, 2014
(86) PCT No.: PCT/EP2014/078209

§ 371 Date: Jun. 15, 2016

(30) Foreign Application Priority Data
Dec. 17, 2013 (EP) 13197765.4

(51) Int. Cl. B01J 19/26; B05B 7/08; C08G 69/14; B01J 4/00; C08G 69/18; C08G 69/04

(52) U.S. Cl. CPC B01J 19/26; C08G 69/18; C08G 69/04; C08G 69/14; B01J 4/002; B05B 7/0846; B01J 2204/005; B01J 2219/185

(57) ABSTRACT

The invention relates to a method for producing polyamides by means of a spray nozzle arrangement for the collision of spray jets, comprising at least one spray nozzle forming a first spray jet having a first spray jet cross-sectional surface and a first spray jet longitudinal extension axis, and comprising a second spray jet forming a second spray jet having a second spray jet cross-sectional surface and a second spray jet longitudinal extension axis, wherein the first and second spray jets have a spray direction that is facing the gravitational field, and are arranged opposite one another such that in a spray direction facing the gravitational field, the formed spray jets collide in a collision area. The invention is characterized in that the angle between the first and the second spray jet is in the range of 5° to 170°, and that the first and second spray nozzles are arranged such that upon colliding, the first spray jet cross-sectional surface of the first spray jet forms an intersection with the second spray jet cross-sectional surface of the second spray jet.

### BACKGROUND OF THE INVENTION

The present invention relates to a spray nozzle arrangement for colliding spray jets and to a method of producing polyamides with this spray nozzle arrangement.

### RELATED ART

Spray nozzle arrangements for colliding spray jets are known in the prior art.

Two spray jets are therein aligned such that they meet or collide at a specified angle. The momentum transfer of two mutually impinging spray jets can lead to unification of individual droplets of the spray jets and in a gravitational field to the formation of a fall line of, for example, individual droplets or alternatively to atomization of the spray jets and to the formation of a spray cone.

JP 11049805 describes a method of spray polymerization with first and second slit type nozzles wherein the angle between the emerging slit type nozzle spray jets is supposed to be greater than 15° and the slit spray jets collide to form a falling curtain of mixed liquid from the spray jets. Droplet sizes on the order of millimeters are obtained according to FIGS. 4 and 5.

JP10204105 describes a method of spray polymerization with first and second nozzles wherein the angle between the emerging nozzle spray jets is supposed to be greater than 15° and the spray jets collide to form a fall line of mixed liquid from the spray jets.

U.S. Pat. No. 7,288,610 B2 and EP 1424346 A4 describe methods of droplet polymerization with the mixture of first and second liquids in a gas phase wherein at least one of the two liquids has the shape of a three-dimensionally expanding film of liquid. The prior art is depicted in FIG. 1 as being two jets of liquid which collide to form a droplet-shaped fall line. The prior art as depicted in FIG. 2 is two films of liquid which issue from slit type nozzles and combine to form one curtain of liquid.

US 2003/153709 discloses a process and apparatus for the continuous preparation of homo- or copolymers by free-impinging-jet micromixing of fluids. At least two spray jets are arranged therein at an angle relative to each other and coincide at a point of impingement to form one resultant spray jet. At the same time, at least one third spray jet is directed at the one point of impingement. There is no disclosure of this apparatus being used to produce polyamides.

WO 2007/096383 discloses a method and apparatus for conducting chemical and physical processes wherein reactants are nozzled onto a collision point and a product is obtained by mixing the reactants. The nozzle jets are oriented towards each other at an angle. A method of producing polymers is not disclosed.

DE 17 95 358 describes a process and apparatus for producing shaped polyamide articles wherein lactam melts are forced simultaneously through two heated pipes into the polymerizing mixture. In particular, the direction of the melts is horizontal and there are no free jets colliding with each other.

DE 17 79 037 describes a mixing head for producing plastics by mixing at least two mutually reactive liquids in a mixing chamber. The liquids to be mutually reacted meet in an obliquely upwards direction to form a conjoint, premixed jet impinging on the upper part of the walling of the mixing chamber. As the jet/mixture flows back in the direction of the outlet opening, this mixture crosses the incoming jets and becomes thoroughly commingled in the process.

U.S. Pat. No. 4,765,540 describes a process and apparatus for generating a plurality of spray jets wherein the spray jets do not intersect and do not collide. There is further an improved process wherein particles are introduced into the spray jet(s).

Known spray nozzle arrangements for colliding spray jets are still in need of improvement and often have the disadvantage of fouling, in particular in the region between the spray nozzles. To reduce fouling, positions susceptible to fouling are also, for example, flushed with gas streams which, on the other hand, results in a disadvantageous consumption of gas and entails providing additional gas metering devices. The prior art further discloses generated droplet sizes in the millimeter range, which corresponds to large particle sizes.

The problem addressed by the present invention is therefore that of providing an improved spray nozzle arrangement for colliding spray jets which avoids the aforementioned disadvantages. More particularly, in providing this spray nozzle arrangement there shall also be provided a method of producing polyamide, in particular polyamide particles having a stable and narrow particle size distribution curve, whereby the particle sizes can be varied during ongoing production without output outage and production capacity can be expanded in a simple and space-saving manner, with low susceptibility to fouling and reduced shutdowns for cleaning. The low propensity to fouling shall further make it possible deployment of a flushing device for example with a gas.

### SUMMARY OF THE INVENTION

It has now been found that, surprisingly, this problem is solved by a method using a spray nozzle arrangement according to claim 1.

The spray nozzle arrangement according to the present invention differs from conventional spray nozzle arrangements in having such an alignment of two spray nozzles that the spray jets collide to form not, for example, three-dimensional spray cones having a large circular base area, but a collision spray fan having an essentially elongate base line in a gravitational field. To increase production capacity, a plurality of spray nozzle arrangements according to the present invention can be arranged in succession such that a plurality of resultant collision spray fans enhance the production capacity with low space requirements. To increase production capacity, moreover, a modular expansion of the spray nozzle arrangement according to the present invention is also possible. Compared with conventional spray nozzle arrangements, the spray nozzle arrangement according to the present invention does not exhibit any fouling within the nozzles nor in the region around the spray nozzles. The method of producing polyamides in the manner of the present invention by using the spray nozzle arrangement of the present invention provides substantially more stable and narrower size distributions for the particles obtained compared with conventional methods or processes.

The present invention accordingly utilizes a spray nozzle arrangement for colliding spray jets comprising at least a first spray nozzle forming a first spray jet with a first spray jet cross-sectional area and a first spray jet longitudinal extent axis, wherein the first spray jet longitudinal extent axis is aligned in a gravitational field in a first vertical plane, and a second spray nozzle forming a second spray jet with a second spray jet cross-sectional area and a second spray jet longitudinal extent axis, wherein the second spray jet longitudinal extent axis is aligned in a gravitational field in a second vertical plane, wherein the first and second spray nozzles have a spray direction facing the gravitational field and are arranged relative to each other such that the resultant spray jets collide in a collision region in the spray direction facing the gravitational field, wherein the angle between the first and second spray jets is in the range from 5° to 170° and the first and second spray nozzles are arranged such that the first spray jet cross-sectional area of the first spray jet combines with the second spray jet cross-sectional area of the second spray jet to form an intersection set on collision.

A suitable embodiment of the present invention utilizes an assembly comprising two or more serially arranged spray nozzle arrangements as defined hereinabove and hereinbelow.

The present invention provides a method of producing polyamides with a spray nozzle arrangement or with an assembly of spray nozzle arrangements, comprising the steps of:
a) providing a first fluid spray composition and a second fluid spray composition with the proviso that
   the first and/or second fluid spray composition comprises one or more components capable of polyamide formation which are selected from: lactams, aminocarboxylic acids, aminocarboxamides, aminocarbonitriles, diamines, dicarboxylic acids, dicarboxylic acid/diamine salts, dinitriles and mixtures thereof,
   in the event of an activated anionic lactam polymerization only one of the two fluid spray compositions comprises at least one activator and only the other comprises at least one catalyst,
b) spraying either of the two fluid spray compositions through the first or second spray nozzle (D1, D2) to obtain a first spray jet (S1, S2) and spraying the other fluid spray compositions through the other spray nozzle (D1, D2) to obtain a second spray jet (S1, S2),
c) colliding the first spray jet (S1) with the second spray jet (S2) whereby the two fluid spray compositions combine to form a mixture which is capable of polyamide formation and which reacts to form a polyamide and a collision spray fan (F) which is vertically aligned in the gravitational field forms between the spray nozzle arrangement,
d) discharging the polyamide obtained in step c),
e) optionally postpurifying the polyamide discharged in step d),
f) optionally drying the polyamide discharged in step d) and/or postpurified in step e).

The present invention further provides for the use of a polyamide reaction product obtained with the spray nozzle arrangement and/or obtainable by the method of producing polyamides with the spray nozzle arrangement.

### Embodiments of the Invention

The present invention specifically comprises the following preferred embodiments:
1. A preferred embodiment of the present invention is a spray nozzle arrangement for colliding spray jets, comprising at least a first spray nozzle forming a first spray jet with a first spray jet cross-sectional area and a first spray jet longitudinal extent axis, wherein the first spray jet longitudinal extent axis is aligned in a gravitational field in a first vertical plane, and a second spray nozzle forming a second spray jet with a second spray jet cross-sectional area and a second spray jet longitudinal extent axis, wherein the second spray jet longitudinal extent axis is aligned in a gravitational field in a second vertical plane, wherein the first and second spray nozzles have a spray direction facing the gravitational field and are arranged relative to each other such that the resultant spray jets collide in a collision region in the spray direction facing the gravitational field, wherein the angle between the first and second spray jets is in the range from 5° to 170° and the first and second spray nozzles are arranged such that the first spray jet cross-sectional area of the first spray jet combines with the second spray jet cross-sectional area of the second spray jet to form an intersection set on collision.
2. The spray nozzle arrangement according to the preceding embodiment of the invention wherein the first and second spray nozzles are arranged such that the first vertical plane in the gravitational field is in a parallel or straight line alignment relative to the second vertical plane in the gravitational field.
3. The spray nozzle arrangement according to either of the preceding embodiments of the invention wherein the first and second spray nozzles are arranged such that the intersection set is not a congruent overlap of the first spray nozzle cross-sectional area with the second spray nozzle cross-sectional area and a shearing plane is formed between the first and second spray jets.
4. The spray nozzle arrangement according to any of the preceding embodiments of the invention wherein the first spray jet cross-sectional area and the second spray jet cross-sectional area are not identical and the first and second spray nozzles are arranged such that the first spray jet cross-sectional area of the first spray jet combines with the second spray jet cross-sectional area of the second spray jet to form a subset on collision.
5. The spray nozzle arrangement according to any of the preceding embodiments of the invention wherein the first and second spray nozzles are aligned such that the first spray jet collides with the second spray jet in the collision region to form a collision spray fan extending from the collision region vertically in the gravitational field.
6. The spray nozzle arrangement according to any of the preceding embodiments of the invention wherein the first and second spray nozzles are aligned such that the collision spray fan arranged vertically in the gravitational field following the collision of the first with the second spray jet is arranged in the gravitational field in an angle in the range from 0< to <½π and π< to <3/2π or in the range from ½π< to <π and 3/2π to <2π between the vertical plane of the collision spray fan and a vertical plane perpendicular to the first and second vertical planes.
7. The spray nozzle arrangement according to any of the preceding embodiments of the invention wherein the first and second spray nozzles are aligned such that the collision spray fan vertically arranged in the gravitational field from the collision region after the collision of the first with the second spray jet has an opening angle in the range from 1° to 170°, preferably in the range from 20° to 150° and more preferably in the range from 30° to 120°.
8. The spray nozzle arrangement according to any of the preceding embodiments of the invention wherein the first and second spray nozzles are aligned such that the collision spray fan vertically arranged in the gravitational field from the collision region after the collision of the first with the second spray jet has a base area, wherein the geometric shape of the base area is selected from a line, an oval, a narrow rectangle, a curve, a circular arc, a cone and combinations thereof.
9. The spray nozzle arrangement according to any of the preceding embodiments of the invention wherein the first and/or second spray nozzle is a perforated plate, a hole type nozzle, a diaphragm, a slit type nozzle or a combination thereof.
10, The spray nozzle arrangement according to any of the preceding embodiments of the invention wherein the first and second spray nozzles are arranged in one nozzle head.
11. The spray nozzle arrangement according to any of the preceding embodiments of the invention wherein the first and/or second spray nozzle has a nozzle channel length in a range of 1 to 1000 μm, preferably in the range from 3 to 50 μm, more preferably in a range of 5 to 20 μm.
12. The spray nozzle arrangement according to any of the preceding embodiments of the invention wherein the first and/or second spray nozzle has a nozzle channel diameter in a range of 5 to 2000 μm, preferably in the range from 25 to 500 μm, more preferably in a range of 50 to 250 μm.
13. The spray nozzle arrangement according to any of the preceding embodiments of the invention wherein the first and/or second spray nozzle is pressurized to a pressure in the range from 2 to 200 bar, preferably in the range from 5 to 100 bar, more preferably in a range from 10 to 50 bar.
14. The spray nozzle arrangement according to any of the preceding embodiments of the invention wherein the first and/or second spray jet cross-sectional area is in a range of 15 to 3 145 000 μm², preferably in the range from 490 to 197 000 μm², more preferably in a range of 1960 to 50 000 μm².
15. The spray nozzle arrangement according to any of the preceding embodiments of the invention wherein the first and/or second spray nozzle are/is arranged such that the angle between the two spray jets is in the range from 5° to 170°, preferably in the range from 30° to 150°, more preferably in a range of 40° to 120°.
16. An assembly comprising two or more serially arranged spray nozzle arrangements as defined in any of the preceding embodiments of the invention.
17. A method of producing polyamides with a spray nozzle arrangement according to any of the preceding embodiments of the invention, comprising the steps of:
   a) providing a first fluid spray composition and a second fluid spray composition with the proviso that
      the first and/or second fluid spray composition comprises one or more components capable of polyamide formation which are selected from: lactams, aminocarboxylic acids, aminocarboxamides, aminocarbonitriles, diamines, dicarboxylic acids, dicarboxylic acid/diamine salts, dinitriles and mixtures thereof,
      in the event of an activated anionic lactam polymerization only one of the two fluid spray compositions comprises at least one activator and only the other comprises at least one catalyst,
   b) spraying either of the two fluid spray compositions through the first or second spray nozzle (D1, D2) to obtain a first spray jet (S1, S2) and spraying the other fluid spray compositions through the other spray nozzle (D1, D2) to obtain a second spray jet (S1, S2),
   c) colliding the first spray jet (S1) with the second spray jet (S2) whereby the two fluid spray compositions combine to form a mixture which is capable of polyamide formation and which reacts to form a polyamide and a collision spray fan (F) which is vertically aligned in the gravitational field forms between the spray nozzle arrangement,
   d) discharging the polyamide obtained in step c),
   e) optionally postpurifying the polyamide discharged in step d),
   f) optionally drying the polyamide discharged in step d) and/or postpurified in step e).
18. The method according to embodiment 17 of the invention wherein at least step b) is carried out in the presence of an inert gas.
19. The method according to either of embodiments 17 and 18 of the invention wherein the first and/or the second fluid spray composition comprises at least a lactam selected from ε-caprolactam, 2-piperidone (δ-valerolactam), 2-pyrrolidone (γ-butyrolactam), capryllactam, enantholactam, lauryllactam and mixtures thereof.
20. The method according to any of embodiments 17 to 19 of the invention wherein the first or the second fluid spray composition comprises at least an activator selected from diisocyanates, polyisocyanates, diacyl halides and mixtures thereof.
21. The method according to any of embodiments 17 to 19 of the invention wherein the first or the second fluid spray composition comprises at least a catalyst selected from alkali and alkaline earth metals, in particular from sodium, magnesium, hydrides and reaction products thereof, in particular with lactams.
22. The method according to any of preceding embodiments 17 to 21 of the invention wherein the fluid spray compositions provided in step a) have a viscosity in the range from 1 to 2000 mPa·s, preferably in the range from 1 to 300 mPa·s and most preferably in the range from 2 to 10 mPa·s.
23. The method according to any of preceding embodiments 17 to 22 of the invention wherein the spraying in step b) of fluid spray compositions to obtain first and second spray jets is effected at a pressure in the range from 2 to 200 bar, preferably in the range from 5 to 100 bar and more preferably in a range from 10 to 50 bar.
24. The method according to any of preceding embodiments 17 to 23 of the invention wherein the collision spray fan formed in step c) is a fan-shaped flat curtain of spray with an opening angle in the range from 5° to 170°, preferably in the range from 15° to 150° and more preferably in the range from 30° to 120°.
25. The method according to any of preceding embodiments 17 to 24 of the invention wherein the collision spray fan formed in step c) has a base area, wherein the shape of the base area is selected from a line, an oval, a narrow rectangle, a curve, a circular arc, a cone and combinations thereof.
26. The method according to any of preceding embodiments 17 to 25 of the invention wherein the polyamide reaction product obtained in step c) has particle sizes in a range of 2 to 500 μm, preferably in the range from 10 to 200 μm, more preferably in the range of 20 to 100 μm.
27. The method according to any of preceding embodiments 17 to 26 of the invention wherein the polyamide reaction product discharged in step d) has a residual monomer content in the range from 0 to 5%, preferably in the range from 0 to below 3%, most preferably in the range from 0 to below 1%.
28. The method according to any of preceding embodiments 17 to 27 of the invention wherein the polyamide reaction product discharged in step d) has an overall content of extractable residues in the range from 0.1 to 5%, preferably in the range from 0.1 to below 4%, most preferably in the range from 0.1 to below 2%.
29. The method according to any of preceding embodiments 17 to 28 of the invention wherein the postpurifying in step e) is effected with solvents selected from a group of water, acetone, alcohols, combinations thereof.
30. The method according to any of preceding embodiments 17 to 29 of the invention wherein the drying in step f) is effected at a temperature in the range from 50 to 200° C., preferably in the range from 80 to 150′C and most preferably in the range from 100 to 120° C.
31. The method according to any of preceding embodiments 17 to 30 of the invention wherein the polyamide reaction product obtained has a number-average molecular weight Mₙ in the range from 5000 to 50 000 g/mol.
32. The method according to any of preceding embodiments 17 to 31 of the invention wherein the polyamide obtained has a polydispersity PD of at most 4.5.
33. Use of a spray nozzle arrangement as defined in any of embodiments 1 to 15 or of an assembly as defined in embodiment 16 for a chemical synthesis, comprising the step of colliding the spray jets to form a reaction-capable mixture and to initiate a reaction.
34. The use according to embodiment 33 for a polymerization, preferably for an anionic lactam polymerization.
35. Use of a polyamide reaction product obtained with a spray nozzle arrangement according to any of embodiments 1 to 16 for production of pellets, films, fibers, shaped articles or three-dimensional structures.
36. Use of a polyamide reaction product obtainable by a method according to any of embodiments 17 to 32 for production of pellets, films, fibers, shaped articles or three-dimensional structures.

### DETAILED DESCRIPTION OF THE INVENTION

For the purposes of the present invention, a collision of spray jets is to be understood as meaning a collision between constituents of spray jets.

For the purposes of the present invention, spray jet cross-sectional area is the area of a spray jet at a cut through the spray jet perpendicular to the longitudinal extent axis of the spray jet.

For the purposes of the present invention, spray jet longitudinal extent axis is the imaginary axis of a spray jet in the longitudinal direction of the spray jet.

For the purposes of the present invention, the expression “a vertical plane aligned in a gravitational field” is to be understood as meaning an imaginary two-dimensional object which is defined by two vectors with one of the two vectors being arranged in the direction of the gravitational field. The other one of the two vectors is arranged in the direction of a spray jet longitudinal extent axis. A spray jet can be sprayed at various angles within this two-dimensional vector space.

For the purposes of the present invention, the expression “a spray direction facing the gravitational field” is to be understood as meaning a direction which a spray jet has in its spray jet longitudinal extent axis, which points to the Earth's magnetic field and does not point away from the Earth's magnetic field.

For the purposes of the present invention, a collision region is a region in which constituents of spray jets collide.

For the purposes of the present invention, an enclosed angle is the smaller angle, also called internal angle, between intersecting spray jets.

For the purposes of the present invention, the intersection set is the common set of intersecting spray jet cross-sectional areas as spray jets collide. For example, the intersection set of two spray jets is the set of those elements which are part of not only one of the spray jets but also of the other one of the spray jets. In addition, each of the two spray jets may also comprise an amount of elements which do not form part of the other spray jet. For example, the collision in a gravitational field of intersecting spray jet cross-sectional areas of two opposite spray jets arranged at a specified angle relative to each other results in the formation of a collision spray fan. The angle, known as the shearing angle, at which the collision spray fan formed in the course of the collision in the gravitational field is arranged between the spray jets is dependent on the attitude of the shearing plane between the spray jets in that the shearing plane is influenced by the position and the area of the intersection set in which the spray jets collide.

Preferably, the first and second spray nozzles are arranged such that the first vertical plane in the gravitational field is in a parallel or straight line alignment relative to the second vertical plane in the gravitational field.

For the purposes of the present invention, straight line is to be understood as arranged on an imaginary line.

Preferably, the first and second spray nozzles are arranged such that the intersection set is not a congruent overlap of the first spray nozzle cross-sectional area with the second spray nozzle cross-sectional area and a shearing plane is formed between the first and second spray jets.

For the purposes of the present invention, a shearing plane is a plane of relative displacement between overlapping portions of spray jets.

Preferably, the first spray jet cross-sectional area and the second spray jet cross-sectional area are not identical and the first and second spray nozzles are arranged such that the first spray jet cross-sectional area of the first spray jet combines with the second spray jet cross-sectional area of the second spray jet to form a subset on collision.

For the purposes of the present invention, identical is to be understood as meaning a coincidence in the geometric shape and size of the spray jet cross-sectional area.

For the purposes of the present invention, subset in connection with an intersection of spray jet cross-sectional areas which is caused by collision of spray jets as meaning that every element of one spray jet is also an element of the other spray jet. This applies even though the other one of the two spray jets may also comprise a set of elements which do not form part of that one spray jet although the amount of elements of the one spray jet is always also an element of the other spray jet.

Preferably, the first and second spray nozzles are aligned such that the first spray jet collides with the second spray jet in the collision region to form a collision spray fan extending from the collision region vertically in the gravitational field.

For the purposes of the present invention, a collision spray fan is the fan-shaped spreading of first and/or second spray jet elements which starts from the collision region after the spray jets have collided.

Preferably, the first and second spray nozzles are aligned such that the collision spray fan arranged vertically in the gravitational field following the collision of the first with the second spray jet is arranged in the gravitational field in an angle in the range from 0< to <½π and π< to <3/2π or in the range from ½π< to <π and 3/2π to <2π between the vertical plane of the collision spray fan and a vertical plane perpendicular to the first and second vertical planes.

Preferably, the first and second spray nozzles are aligned such that the collision spray fan vertically arranged in the gravitational field from the collision region after the collision of the first with the second spray jet has an opening angle in the range from 1° to 170°, preferably in the range from 20° to 150° and more preferably in the range from 30° to 120°.

For the purposes of the present invention, an opening angle is the angle which, proceeding from the collision region, opens between the edge regions of the collision spray fan which bound the collision spray fan on both sides. The opening angle is in fact the enclosed, smaller internal angle between the edge regions of the collision spray fan which bound the collision spray fan on both sides.

Preferably, the first and second spray nozzles are aligned such that the collision spray fan vertically arranged in the gravitational field from the collision region after the collision of the first with the second spray jet has a base area, wherein the geometric shape of base area is selected from a line, an oval, a narrow rectangle, a curve, a circular arc, a cone and combinations thereof.

The position and area of the subset in which the spray jets collide influences the geometric shape/configuration of the collision spray fan between the spray jets which is formed in the collision. In addition, the shape of the collision spray fan and in particular also the particle size and the particle size distribution in the collision spray fan are influenced by further parameters, for example the viscosity of the spray composition, the spray jet speed and the surface tension of the spray composition.

For the purposes of the present invention, the geometric shape of the base area is to be understood as meaning the geometric shape evident for a cross section through the vertically arranged collision spray fan.

Preferably, the first and/or second spray nozzle is a perforated plate, a hole type nozzle, a diaphragm, a slit type nozzle or a combination thereof.

Preferably, the first and second spray nozzles are arranged in one nozzle head.

Preferably, the first and/or second spray nozzle has a nozzle channel length in a range of 1 to 1000 μm, preferably in the range from 3 to 50 μm, more preferably in a range of 5 to 20 μm.

For the purposes of the present invention, nozzle channel length is the length of a channel through which a spray jet flows and which leads to the point of exit of the spray jet from the spray nozzle.

Preferably, the first and/or second spray nozzle has a nozzle channel diameter in a range of 5 to 2000 μm, preferably in the range from 25 to 500 μm, more preferably in a range of 50 to 250 μm.

For the purposes of the present invention, the nozzle channel diameter is the diameter of a channel length is the length of a channel through which a spray jet flows and which leads to the point of exit of the spray jet from the spray nozzle.

Preferably, the first and/or second spray nozzle is pressurized to a pressure in the range from 2 to 200 bar, preferably in the range from 5 to 100 bar, more preferably in a range from 10 to 50 bar.

Preferably, the first and/or second spray jet cross-sectional area is in a range of 15 to 3 145 000 μm², preferably in the range from 490 to 197 000 μm², more preferably in a range of 1960 to 50 000 μm².

For the purposes of the present invention, a spray jet cross-sectional area is the cross-sectional area of a spray jet in a region which extends from point of exit of the spray jet from a spray nozzle into the collision region.

Preferably, the first and/or second spray nozzle are/is arranged such that the angle between the two spray jets is in the range from 5° to 170°, preferably in the range from 30° to 150°, more preferably in a range of 40° to 120°.

Preferably, two or more, for example 2, 3, 4, 5, 6, 7, 8, 9, 10, 11, 12, spray nozzle arrangements are arranged serially.

For the purposes of the present invention, spray nozzle arrangements arranged serially are an arrangement of two or more, for example 2, 3, 4, 5, 6, 7, 8, 9, 10, 11, 12, pairs of spray nozzles in parallel.

### Production of Polyamides

Polyamides are among those polymers with high production volumes worldwide and are mainly used in fibers, engineering materials and films but also for a multiplicity of other purposes. Nylon-6 is the most commonly produced polyamide, its share amounting to about 57%. Hydrolytic polymerization of ε-caprolactam is the classic way to produce nylon-6 (polycaprolactam) and is industrially still very significant. Conventional hydrolytic processes are described for example in Ullmann's Encyclopedia of Industrial Chemistry, Online Edition Mar. 15, 2003, Vol. 28, pp. 552-553 and Kunststoffhandbuch, ¾ Engineering Thermoplastics: Polyamides, Carl Hanser Verlag, 1998, Munich, pp. 42-47 and 65-70. In the first step of the hydrolytic polymerization process, some of the lactam used reacts with water by ring opening to form the corresponding ω-aminocarboxylic acid. The latter then reacts with further lactam in polyaddition and polycondensation reactions to form the corresponding polyamide. In a preferred version, ε-caprolactam reacts with water by ring opening to form aminocaproic acid and, which then goes on to form nylon-6.

In principle, ionic polymerization, in particular anionic polymerizations, may also be carried out.

It is also known in principle to produce polyamides by activated anionic lactam polymerization. Lactams, for example caprolactam, lauryllactam, piperidone, pyrrolidone, etc., are ring-openingly polymerized in a base-catalyzed anionic polymerization reaction. This is generally accomplished by polymerizing a lactam melt comprising an alkaline catalyst and a so-called activator (or else co-catalyst or initiator) at elevated temperatures. The activated anionic lactam polymerization process is described with reference to ε-caprolactam in Polyamides, Kunststoff Handbuch, Vol. 3/4, ISBN 3-446-16486-3, 1998, Carl Hanser Verlag, pp. 49-52 and in Macromolecules, Vol. 32, No. 23 (1999), pp. 7726.

An alternative way to produce polyamides involves the polycondensation of aminonitriles. This includes, for example, the production of nylon-6 from 6-aminocapronitrile (ACN). In a conventional procedure, this method comprises a nitrile hydrolysis and subsequent amine-amidation. It is generally carried out in separate reaction steps in the presence of a heterogeneous catalyst, such as TiO₂. A multistaged procedure has been found to be useful in practice, since the two reaction steps have different requirements regarding water content and completeness of reaction. It is also frequently advantageous with this route to subject the polymer obtained to a purifying operation to remove monomers/oligomers.

### Step a)

Step a) of the method according to the present invention preferably comprises providing at least one spray composition comprises one or more components capable of polyamide formation which are selected from: lactams, aminocarboxylic acids, aminocarboxamides, aminocarbonitriles, diamines, dicarboxylic acids, dicarboxylic acid/diamine salts, dinitriles and mixtures thereof.

For the purposes of the present invention, a spray composition is a composition with which a spray nozzle arrangement can be charged and which is suitable for spraying with a nozzle arrangement, i.e., the spray composition is subdivisible into very fine droplets as an aerosol (mist) in a gas, for example air or an inert gas.

By way of component capable of polyamide formation, the spray composition provided in step a) preferably comprises at least a C₅-C₁₂ lactam and/or an oligomer thereof. The lactams are more particularly selected from ε-caprolactam, 2-piperidone (δ-valerolactam), 2-pyrrolidone (γ-butyrolactam), capryllactam, enantholactam, lauryllactam, their mixtures and oligomers thereof.

Step a) preferably provides at least one spray composition comprising at least one lactam or at least one aminocarbonitrile and/or oligomers of these monomers. In a specific embodiment, the first and/or second fluid spray composition comprises at least one comonomer selected from ω-aminocarboxylic acids, ω-aminocarboxamides, ω-aminocarboxylic acid salts, ω-aminocarboxylic esters, diamines and dicarboxylic acids, dicarboxylic acid/diamine salts, dinitriles and mixtures thereof.

In a specific embodiment, the method of the present invention is used to produce homopolyamides. Homopolyamides are derived from one lactam or one aminocarboxylic acid and can be described by means of a single repeat unit. Nylon-6 foundation stones can be constructed for example from caprolactam, aminocapronitrile, aminocaproic acid or mixtures thereof. Preferred homopolyamides are nylon-6 (PA 6, polycaprolactam), nylon-7 (PA 7, polyenantholactam or polyheptanamide), nylon-10 (PA 10, polydecanamide), nylon-11 (PA 11, polyundecanolactam) and nylon-12 (PA 12, polydodecanolactam). Particular preference is given to PA 6 and PA 12, while PA 6 is especially preferred.

In a further specific embodiment, the method of the present invention is used for production of copolyamides. Copolyamides are derived from two or more different monomers, the monomers being linked to each other by an amide bond in each case. Possible copolyamide building blocks can derive for example from lactams, aminocarboxylic acids, dicarboxylic acids and diamines. Preferred copolyamides are polyamides of hexamethylenediamine and adipic acid (PA 66) and also polyamides of caprolactam, hexamethylenediamine and adipic acid (PA 6/66). Copolyamides may comprise the incorporated polyamide building blocks in various ratios.

To produce copolyamides, step a) preferably comprises providing a monomer mixture which in addition to at least one lactam or aminocarbonitrile and/or oligomer thereof comprises at least one monomer (M1) copolymerizable therewith and capable of forming amide bonds.

Suitable monomers (M1) are dicarboxylic acids, for example aliphatic C₄₋₁₀ alpha, omega-dicarboxylic acids, such as succinic acid, glutaric acid, adipic acid, pimelic acid, suberic acid, azelaic acid, sebacic acid and dodecanedioic acid. Aromatic C₈₋₂₀ dicarboxylic acids, such as terephthalic acid and isophthalic acid, can also be used.

Diamines useful as monomers (M1) include α,ω-diamines having four to ten carbon atoms, such as tetramethylenediamine, pentamethylenediamine, hexamethylenediamine, heptamethylenediamine, octamethylenediamine, nonamethylenediamine and decamethylenediamine. Hexamethylenediamine is particularly preferred.

Especially the salt of adipic acid and hexamethylenediamine, known as 66 salt, is preferred among those salts of the recited dicarboxylic acids and diamines which are useful as monomers (M1).

In a further specific embodiment, the method of the present invention is used for production of polyamide copolymers. Polyamide copolymers in addition to the basic polyamide building blocks comprise further basic building blocks which are not bonded together by amide bonds (=monomers M2). The proportion of incorporated monomers M2 in polyamide copolymers is preferably at most 40 wt %, more preferably at most 20 wt % and especially at most 10 wt %, based on the overall weight of the basic building blocks of the polyamide copolymer.

To produce polyamide copolymers, step a) preferably comprises providing a monomer mixture comprising
at least one lactam or aminocarbonitrile and/or oligomer thereof,
optionally at least one monomer (M1) copolymerizable therewith, and
at least one monomer (M2) copolymerizable therewith.

Preferred monomers (M2) are lactones. Preferred lactones include, for example, ε-caprolactone and/or γ-butyrolactone.

Polyamides are obtainable using one or more chain transfer agents, for example aliphatic amines or diamines, such as triacetonediamine or a mono- or dicarboxylic acid, such as propionic acid and acetic acid, or aromatic carboxylic acids, such as benzoic acid or terephthalic acid.

In the event of an activated anionic lactam polymerization process, one of the two fluid spraying compositions comprises at least an activator and the other comprises at least a catalyst.

Suitable catalysts for employment in the method of the present invention are commonly used catalyst of the type customarily employed for anionic polymerization. They include specifically compounds that enable the formation of lactam anions. Lactam anions themselves may likewise act as a catalyst. Catalysts of this type are known for example from Polyamides, Kunststoff Handbuch, Vol. 3/4, 1998, Carl Hanser Verlag, pp. 52.

The catalyst is preferably selected from sodium caprolactamate, potassium caprolactamate, bromide magnesium caprolactamate, chloride magnesium caprolactamate, magnesium bis-caprolactamate, sodium hydride, sodium, sodium hydroxide, sodium methoxide, sodium ethoxide, sodium propoxide, sodium butoxide, potassium hydride, potassium, potassium hydroxide, potassium methoxide, potassium ethoxide, potassium propoxide, potassium butoxide and mixtures thereof.

It is particularly preferable to employ a catalyst selected from sodium hydride, sodium and sodium caprolactamate. Sodium caprolactamate in particular is employed as catalyst. In a specific embodiment, a solution of sodium caprolactamate in caprolactam is employed. A mixture of this type is commercially available under the name Brüggolen® C10 from BrüggemannChemical, L. Brüggemann Kommanditgesellschaft, Germany and comprises 17 to 19 wt % of sodium caprolactamate in caprolactam. A likewise suitable catalyst is, in particular, bromide magnesium caprolactamate, e.g., Brüggolen® C1 from BrüggemannChemical, Germany.

The molar ratio of lactam to catalyst can be varied within wide limits, generally it is in the range from 1:1 to 10 000:1, preferably in the range from 5:1 to 1000:1 and more preferably in the range from 1:1 to 500:1.

The polymerizable lactam composition of the present invention preferably comprises at least one activator.

Suitable activators for the anionic polymerization process are lactams N-substituted by electrophilic moieties, an example being an acyllactam.

Useful activators further include precursors to such activated N-substituted lactams, which combine with the lactam to form an activated lactam in situ. The number of growing chains depends on the activator quantity. Useful activators include in general isocyanates, acid anhydrides and acyl halides and/or reaction products thereof with the lactam monomer.

Useful activators include aliphatic, cycloaliphatic, araliphatic and aromatic diisocyanates. Useful aliphatic diisocyanates include, for example, tetramethylene diisocyanate, hexamethylene diisocyanate, octamethylene diisocyanate, decamethylene diisocyanate, undecamethylene diisocyanate and dodecamethylene diisocyanate. Useful aliphatic diisocyanates include, for example, 4,4′-methylenebis-(cyclohexyl) diisocyanate, isophorone diisocyanate and 1,4-diisocyanatocyclohexane. Useful aromatic diisocyanates include, for example, tolyl diisocyanate, 4,4′-diphenyl-methane diisocyanate, xylylene diisocyanate and tetramethylxylylene diisocyanate.

It is further possible to use polyisocyanates obtainable from the abovementioned diisocyanates, or mixtures thereof, by linking via urethane, allophanate, urea, biuret, uretdione, amide, isocyanurate, carbodiimide, uretoneimine, oxadiazinetrione or iminooxadiazinedione structures. These include, for example, the isocyanurate of hexamethylene diisocyanate. This is commercially available under the name Basonat HI 100 from BASF SE, Germany.

Useful activators further include aliphatic diacyl halides, butylenediacyl chloride, butylenediacyl bromide, hexamethylenediacyl chloride, hexamethylenediacyl bromide, octamethylenediacyl chloride, octamethylenediacyl bromide, decamethylenediacyl chloride, decamethylenediacyl bromide, dodecamethylenediacyl chloride, dodecamethylenediacyl bromide, 4,4′-methylenebis(cyclohexanecarbonyl chloride), 4,4′-methylenebis(cyclohexanecarbonyl bromide), isophoronediacyl chloride, isophoronediacyl bromide; and also aromatic diacyl halides, such as tolylmethylenediacyl chloride, tolylmethylenediacyl bromide, 4,4′-methylenebis-(phenylcarbonyl chloride), 4,4′-methylenebis(phenylcarbonyl bromide). Mixtures of the recited compounds can also be employed as activators.

Particular preference is given to a polymerizable lactam composition comprising an activator comprising at least one compound selected from the group consisting of aliphatic diisocyanates, aromatic diisocyanates, polyisocyanates, aliphatic diacyl halides and aromatic diacyl halides.

The activator employed in a preferred embodiment is at least one compound selected from hexamethylene diisocyanate, hexamethylene 1,6-dicarbamoylcaprolactam (i.e., caprolactam-blocked 1,6-hexamethylene diisocyanate), isophorone diisocyanate, hexamethylenediacyl bromide, hexamethylenediacyl chloride and mixtures thereof. It is particularly preferable to employ hexamethylene 1,6-dicarbamoylcaprolactam as activator. This is commercially available as Brüggolen® C20 from BrüggemannChemical, Germany.

The molar ratio of lactam to activator can be varied within wide limits and is generally in the range from 1:1 to 10 000:1, preferably in the range from 5:1 to 2000:1 and more preferably in the range from 20:1 to 1000:1.

### Step b)

Step b) of the method according to the present invention comprises spraying either of the two fluid spray compositions through the first or second spray nozzle to obtain a first spray jet and spraying the other fluid spray compositions through the other spray nozzle to obtain a second spray jet.

For the purposes of the present invention, spraying refers to subdividing the fluid spray composition into vary fine droplets as an aerosol (mist) in a gas, for example air, an inert gas, combinations thereof. The resultant aerosol is also called spray jet. The spray jet can either consist of droplets which all have the same diameter and form a monodisperse spray jet, or comprise differingly sized droplets to form a polydisperse spray jet.

### Step c)

Step c) of the method according to the present invention comprises colliding the first spray jet with the second spray jet whereby the two fluid spray compositions combine to form a mixture which is capable of polyamide formation and which reacts to form a polyamide and a collision spray fan which is vertically aligned in the gravitational field forms between the spray nozzle arrangement.

For the purposes of the present invention, the reaction to form a polyamide reaction product is preferably an ionic polymerization of ε-caprolactam.

For the purposes of the present invention, collision spray fan refers to the fan-shaped spreading out of an aerosol after the collision of spray jets. More particularly, the first and second spray nozzles are aligned such that the collision spray fan vertically arranged in the gravitational field from the collision region after the collision of the first with the second spray jet has a base area, wherein the geometric shape of base area is selected from a line, an oval, a narrow rectangle, a curve, a circular arc, a cone and combinations thereof.

### Step d)

Step d) of the method according to the present invention comprises discharging the polyamide reaction product obtained in step c).

For the purposes of the present invention, discharging is to be understood as meaning any known prior art way to discharge particulate matter. Possibilities include, for example, a screw discharge, a cyclone discharge, a fluidized bed discharge, combinations thereof.

### Step e)

Step e) of method according to the present invention optionally comprises postpurifying the polyamide reaction product discharged in step d).

For the purposes of the present invention, postpurifying is to be understood as meaning in particular washing the discharged polyamide product. Washing can be done with water and/or acetone.

### Step f)

Step f) of the method according to the present invention comprises optionally drying the polyamide reaction product discharged in step d) and/or postpurified in step e).

The drying of polyamides is known in principle to a person skilled in the art. For example, the polyamide reaction product discharged in step d) and/or postpurified in step e) can be dried by contacting with dry air or dry air or dry inert gas or a mixture thereof. It is preferable to dry with an inert gas, for example nitrogen. The polyamide reaction product discharged in step d) and/or postpurified in step e) can also be dried by contacting with superheated steam or a mixture thereof with a gas other than superheated steam, preferably with an inert gas. Customary dryers can be used, examples being countercurrent, cross-flow, pan, tumble, paddle, trickle, cone or shaft dryers, fluidized beds, etc. One suitable mode is to batch dry in a tumble or cone dryer in vacuo. A further suitable mode is that of continuous drying in drying tubes wherethrough a gas is flowed which is inert under the drying conditions. A specific mode applies at least a shaft dryer. Preferably, a hot gas which is inert under the postpolymerization conditions is flowed through the shaft dryer. Nitrogen is a preferred inert gas.

Preferably, in the method of producing polyamides with a spray nozzle arrangement in the manner of the present invention, an inert gas is flowed through the chamber from step b) onward.

Preferably, in the method of producing polyamides with a spray nozzle arrangement in the manner of the present invention, the fluid spray composition is an aqueous spray composition.

Preferably, in the method of producing polyamides with a spray nozzle arrangement in the manner of the present invention, the fluid spray compositions provided in step a) have a viscosity in the range from 1 to 2000 mPa·s, preferably in the range from 1 to 300 mPa·s and most preferably in the range from 1 to 30 mPa·s.

Preferably, in the method of producing polyamides with a spray nozzle arrangement in the manner of the present invention, the spraying in step b) of fluid spray compositions to obtain first and second spray jets is effected at a pressure in the range from 2 to 200 bar, preferably in the range from 5 to 100 bar and more preferably in a range from 10 to 50 bar.

For the purposes of the present invention, the pressure in question is the relative pressure between the inlet and the outlet of a spray nozzle.

Preferably, in the method of producing polyamides with a spray nozzle arrangement in the manner of the present invention, the collision spray fan formed in step c) is a fan-shaped flat curtain of spray with an opening angle in the range from 5° to 170°, preferably in the range from 15° to 150° and more preferably in the range from 30° to 120°.

Preferably, in the method of producing polyamides with a spray nozzle arrangement in the manner of the present invention, the collision spray fan formed in step c) has a base area, wherein the shape of base area is selected from a line, an oval, a narrow rectangle, a curve, a circular arc, a cone and combinations thereof.

Preferably, in the method of producing polyamides in the manner of the present invention, the polyamide reaction product obtained in step c) has particle sizes in a range of 2 to 500 μm, preferably in the range from 10 to 200 μm, more preferably in a range of 20 to 100 μm.

Preferably, in the method of producing polyamides in the manner of the present invention, the polyamide reaction product discharged in step d) has a residual monomer content in the range from 0 to 5%, preferably below 3%, most preferably below 1%.

Preferably, in the method of producing polyamides in the manner of the present invention, the polyamide reaction product discharged in step d) has an overall content of extractable residues in the range from 0.1 to 5%, preferably below 4%, most preferably below 2%.

Preferably, in the method of producing polyamides in the manner of the present invention, the postpurifying in step e) is effected with solvents selected from a group of water, acetone, alcohols, combinations thereof.

Preferably, in the method of producing polyamides in the manner of the present invention, the drying in step f) is effected at a temperature in the range from 50 to 200° C., preferably in the range from 80 to 150° C. and most preferably in the range from 100 to 120° C.

Preferably, in the method of producing polyamides in the manner of the present invention, the polyamide reaction product obtained has a number-average molecular weight Mₙ in the range from 5000 to 50 000 g/mol.

Preferably, in the method of producing polyamides in the manner of the present invention, the polyamide obtained has a polydispersity PD of at most 4.5.

Preferably, the polyamide reaction product obtained with the spray nozzle arrangement of the present invention is used for production of pellets, films, fibers, shaped articles or three-dimensional structures.

Preferably, the polyamide reaction product obtainable with the method of the present invention is used for production of pellets, films, fibers, shaped articles or three-dimensional structures.

The method of the present invention leads to polyamides having particularly advantageous properties. The viscosity number is a suitable measure of the polymer properties obtained.

### FIGURE DESCRIPTION AND EXAMPLES

The invention will now be more particularly described with reference to FIGS. 1 to 5 and Examples A to E.

FIG. 1 shows in schematic form an embodiment featuring a spray nozzle arrangement for performing the inventive method of the present invention,

FIG. 2 shows a schematic form a plan view, and a related oblique view, of an embodiment of the inventive nozzle arrangement with various alignment possibilities for the spray nozzles with reference to spray jets and their spray jet cross-sectional areas for performing the inventive method,

FIG. 3 shows a schematic form a plan view, and a related oblique view, of an embodiment of the inventive nozzle arrangement with various alignment possibilities for the spray nozzles with reference to spray jets and their spray jet cross-sectional areas for performing the inventive method,

FIG. 4 shows in schematic form an embodiment of an arrangement of the inventive nozzle arrangement for performing the inventive method.

FIG. 5 shows the particle size distributions of the obtained products from Examples A to E.

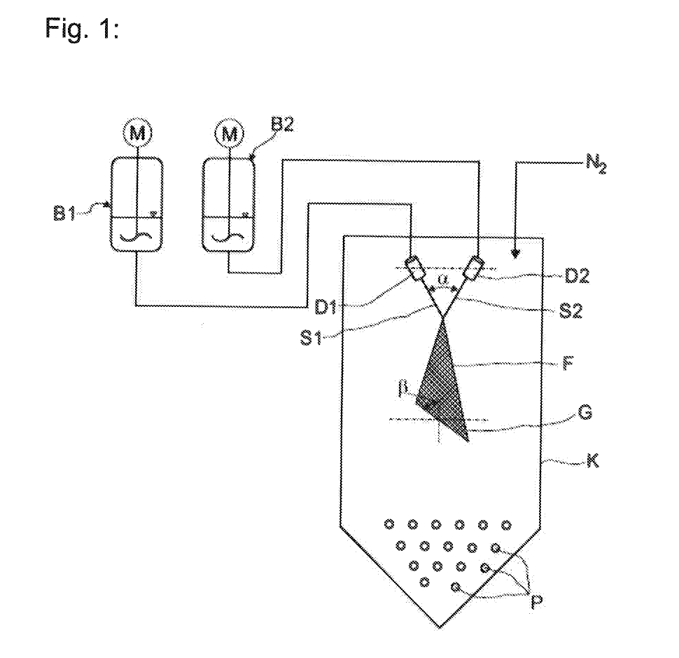

The reference signs used in FIGS. 1 to 4 are as follows:
A1 first spray jet longitudinal-extent axis
A2 second spray jet longitudinal-extent axis
B1 container 1
B2 container 2
D1 first spray nozzle
D2 second spray nozzle
E1 first spray plane
E2 second spray plane
F collision spray fan
F1 first collision spray fan
F2 second collision spray fan
F3 third collision spray fan
F4 fourth collision spray fan
G base area
K chamber
P polymer particle
U intersection set
Q1 first spray jet cross-sectional area
Q2 second spray jet cross-sectional area
S1 first spray jet
S2 second spray jet
T subset
α spray jet intersection angle
β horizontal collision spray fan angle
γ vertical deflection angle

FIG. 1 shows an embodiment featuring a spray nozzle arrangement for performing the inventive method.

A first spray nozzle D1 with a first spray jet S1 and a second spray nozzle D2 with a second spray jet S2 are oppositely arranged in a chamber K at the ceiling thereof such that the first spray jet S1 and the second spray jet S2 collide so as to form a collision spray fan F having a base area G. The collision spray fan F is arranged in a horizontal collision spray fan angle β. In colliding, the spray jets S1 and S2 make it possible for a polymerization to take place. After successful polymerization, polymer particles P can be discharged from the chamber K at the floor thereof. An inert gas, in particular nitrogen, can be flowed through the chamber K in the direction of the extent axis of collision spray fan F. In aligning the first spray nozzle D1 with the first spray jet S1 and the second spray nozzle D2 with the second spray jet S2 to collide with the two spray jets S1, S2, a spray jet intersection angle α is formed between the two spray jets S1, S2. The supply of one of the spray jets, for example the first spray jet S1, can be ensured from a first container B1 via the first spray nozzle D1. In the present example, the first container contains a catalyst as well as a component capable of polymer formation. The supply of the other spray jet, for example the second spray jet S2, can be ensured from a second container B2, containing an activator, via the second spray nozzle D2.

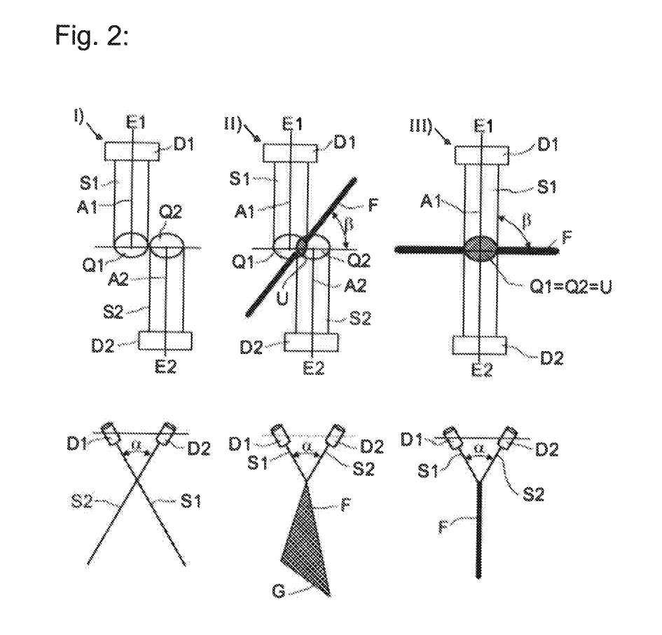

FIG. 2 shows in schematic form a plan view of various alignment possibilities for spray nozzles D1 and D2 to form the vertical spray planes E1 and E2 with reference to spray jets S1 and S2, their spray jet cross-sectional areas Q1 and Q2 and spray jet longitudinal-extent axes A1 and A2 for performing the inventive method.

FIG. 2 I) shows the first spray jet S1 with the first spray jet cross-sectional area Q1 and the second spray jet S2 with the second spray jet cross-sectional area Q2 without the first spray jet colliding with the second spray jet and so no subset or intersection set is formed. No collision spray fan is formed. The vertical spray planes E1 and E2 are in a parallel arrangement with each other.

FIG. 2 II) shows the first spray jet S1 with the first spray jet cross-sectional area Q1 and the second spray jet S2 with the second spray jet cross-sectional area Q2 with the first spray jet colliding with the second spray jet in an edge region of the spray jets S1 and S2, and so the first spray jet cross-sectional area Q1 combines with the second spray jet cross-sectional area Q2 to form an intersection set U. The collision of the first spray jet S1 with the second spray jet S2 lead to the formation of a shearing plane and of the vertical collision spray plan F. The horizontal arrangement of the collision spray fan F is influenced for example by size and position of the intersection set U, jet speed, intensity, momentum, concentration, density, surface tension of the spray composition and the proportion of spray jets S1, S2 which is attributable to undissolved particles, and can be reported in terms of the horizontal collision spray fan angle β. The horizontal collision spray fan angle β between the first and/or the second vertical spray plane E1, E2 and the vertically arranged collision spray fan F can be in the range from 0° to 89° and 180° to 269° or in the range from 91° to 180° and 271° to 360°. The vertical spray planes E1, E2 are in a parallel arrangement with each other.

FIG. 2 III) shows the collision of the first spray jet S1 with the second spray jet S2 in a schematic form wherein the first spray jet cross-sectional area Q1 is equal to the second spray jet cross-sectional area Q2 and is equal to the intersection set U. The collision spray plan F formed in the collision has a collision spray fan angle β of 90° when oppositely disposed equisized spray jet cross-sectional area Q1, Q2 are involved. The vertical spray planes E1, E2 in a straight-line arrangement relative to each other.

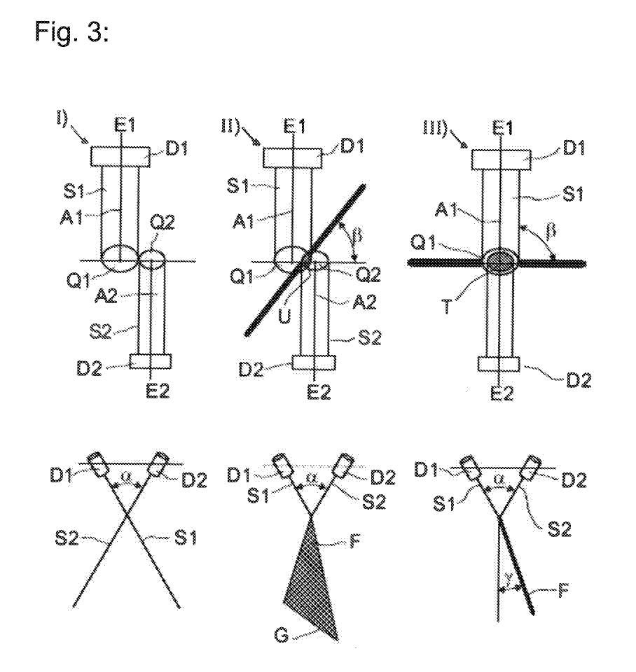

FIG. 3 shows in schematic form a plan view of various alignment possibilities for spray nozzles D1 and D2 to form the vertical spray planes E1 and E2 with reference to spray jets S1 and S2, their spray jet cross-sectional areas Q1 and Q2 and spray jet longitudinal-extent axes A1 and A2 for performing the inventive method, wherein one of the spray jets, presently the second spray jet S2, has a smaller spray jet cross-sectional area Q2 than spray jet cross-sectional area Q1.

FIG. 3 I) shows the first spray jet S1 with the first spray jet cross-sectional area Q1 and the second spray jet S2 with the second, smaller spray jet cross-sectional area Q2 without the first spray jet colliding with the second spray jet and so no subset or intersection set is formed. No collision spray fan is formed. The vertical spray planes E1 and E2 are in a parallel arrangement with each other. The horizontal arrangement of the collision spray fan F is influenced for example by size and position of the intersection set U, jet speed, intensity, momentum, concentration, density, surface tension of the spray composition and the proportion of spray jets S1, S2 which is attributable to undissolved particles, and can be reported in terms of the horizontal collision spray fan angle β. The horizontal collision spray fan angle β between the vertically first and/or the second spray plane E1, E2 and the vertically arranged collision spray fan F can be in the range from 0° to 89° and 180° to 269° or in the range from 91° to 180° and 271° to 360°. The vertical spray planes E1, E2 are in a parallel arrangement with each other.

FIG. 3 III) shows in schematic form the collision of the first spray jet S1 with the second spray jet S2, where the second spray jet cross-sectional area Q2 is a subset T of the first spray jet cross-sectional area Q1. The resultant collision spray fan F has a collision spray fan angle β of 90° when vertical spray planes E1 and E2 in a straight-line arrangement relative to each other are involved. The collision spray fan F formed in the collision can have a conical shape. The shape of the collision spray fan F is influenced for example by size and position of the subset T, jet speed, intensity, momentum, concentration, density, surface tension of the spray composition and the proportion of spray jets S1, S2 which is attributable to undissolved particles. Depending on the aforementioned parameters, the collision of the first S1 of the second spray jet S2 can lead to the formation, proceeding from a collision point, in the gravitational field of a collision spray fan which can also be deflected in a vertical deflection angle γ, which can be arranged an imaginary vertical line through the center of the collision region and the collision spray fan F in the range from 1° to 80°.

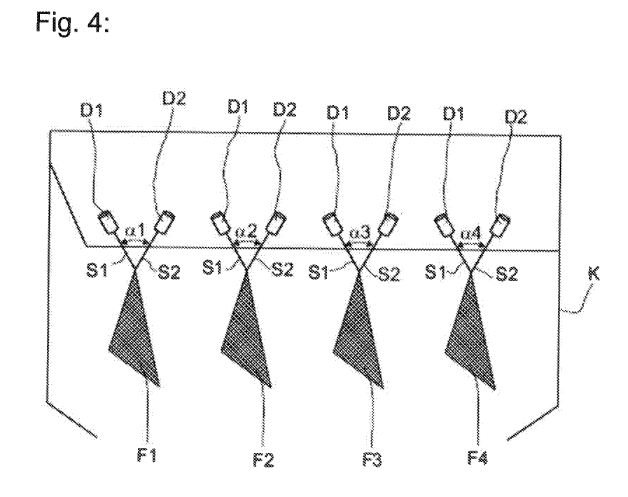

FIG. 4 shows in schematic form an embodiment of an arrangement of the inventive nozzle arrangement for performing the inventive method. Four inventive nozzle arrangements from FIG. 1 are installed in serial succession by way of example. The space-saving formation of the individual collision spray fans F1 to F4 makes possible a simple modular expansion of the inventive nozzle arrangement and increase of production capacities.

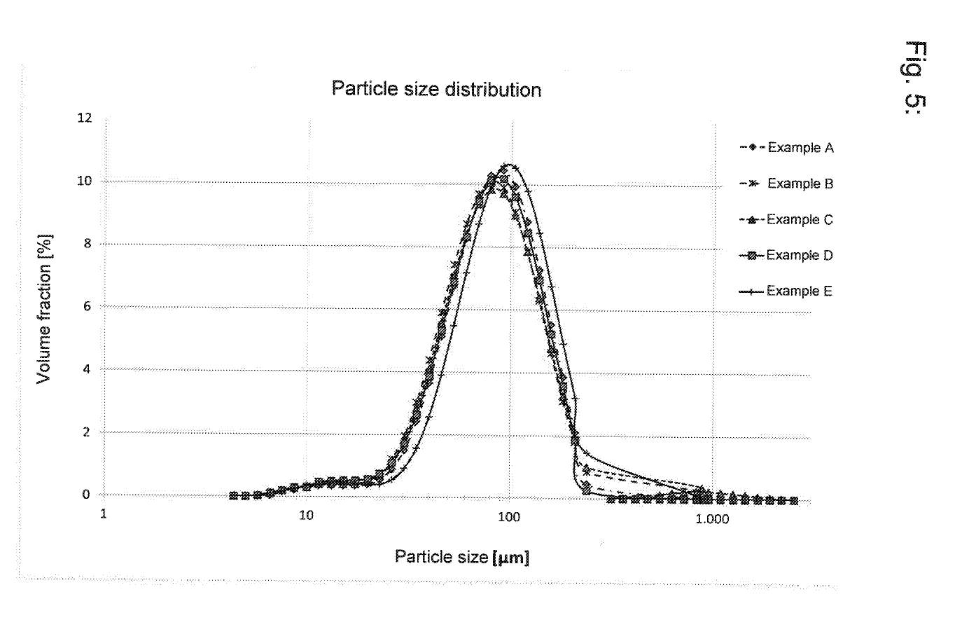

FIG. 5 shows the particle size distributions of the obtained products from Examples A to E. Particle size distribution was determined by laser diffraction using a Mastersizer 2000 from Malvern Instruments. The reported particle size is the diameter of the sphere of equal volume. FIG. 5 depicts the volume fractions in % against the particle size in μm. As is clearly seen in the individual distribution curves, the particle sizes of the A to E products obtained are all in a similar range even after different residence times. The specific surface area was in a range of 0.09 to 0.15 m²/g. The Sauter diameter D[3,2] (or surface-weighted) was in a range of 56 to 65 μm. The DeBroucker mean D[4,3] (or volume-weighted) was in a range of 80 to 100 μm. The Dv10 values were in a range of 34 to 45 μm. The Dv50 values were in a range of 73 to 86 μm. The Dv90 values were in a range of 140 to 157 μm.

### Example A

Two opposite spray nozzles were arranged in the spray nozzle arrangement for colliding spray jets. Each spray nozzle was equipped with a 200 μm diaphragm with a 90 μm filter in front. The two spray nozzles were arranged on one spray head. An angle of 60° was set between the opposite spray nozzles. The interstitial space between the nozzles was flushed with nitrogen to avoid fouling. The nozzles were pressurized to an absolute pressure in the range from 30 to 40 bar. The formulation for the production of nylon-6 comprised the monomer caprolactam at 93.84 wt %, the activator Brüggolen® C20 from BrüggemannChemical at 4.08 wt % and the catalyst Brüggolen® C10 from BrüggemannChemical at 2.08 wt %, based on the overall weight of the formulation. Brüggolen® C20 comprised a blocked diisocyanate in caprolactam at an NCO content of about 17 wt %, based on the overall weight of the Brüggolen® C20. Brüggolen® C10 comprised 17 to 19 wt % of sodium caprolactamate in caprolactam, based on the overall weight of the Brüggolen® C10. The first nozzle was fed with a fluid spray composition comprising caprolactam and activator. The second nozzle was fed with a fluid spray composition comprising caprolactam, catalyst and a dye for better visual detection of the spray jet. The spray nozzles, the feed tank and the pipework lines were heated to a temperature of above 90° C. before spraying. The particles obtained after the collision of the spray jets had an average particle size in the range from 70 to 80 μm. Absolute particle sizes were obtained in a range of 1 to 200 μm. The test was carried out in an inert gas atmosphere comprising nitrogen. As shown in the particle size distribution in FIG. 5, the residence time was 45 min.

The nylon-6 obtained as described above has a number average molecular weight Mₙ in the range from 21 400 to 27 000 g/mol and a polydispersity PD in the range from 3.3 to 4.5.

### Examples B to E

Examples B to E were carried out using the same chemical and technical parameters as reported in Example A, except that anionic PA6 powder was produced in Examples A and C. Examples A to E differ with regard to residence time. The residence times of the individual examples were as follows:

Example A: 45 min

Example B: 1 h 20 min

Example C: 2 h 20 min

Example D: 3 h 20 min

Example E: 4 h 20 min

1.-15. (canceled)

16. A method of producing polyamides with a spray nozzle arrangement for colliding spray jets, comprising the following steps of:
a) providing a first fluid spray composition and a second fluid spray composition with the proviso that
the first and/or second fluid spray composition comprises one or more components capable of polyamide formation which are selected from: lactams, aminocarboxylic acids, aminocarboxamides, aminocarbonitriles, diamines, dicarboxylic acids, dicarboxylic acid/diamine salts, dinitriles and mixtures thereof,
in the event of an activated anionic lactam polymerization only one of the two fluid spray compositions comprises at least one activator and only the other comprises at least one catalyst,
b) spraying either of the two fluid spray compositions through the first or second spray nozzle (D1, D2) to obtain a first spray jet (S1, S2) and spraying the other fluid spray compositions through the other spray nozzle (D1, D2) to obtain a second spray jet (S1, S2),
c) colliding the first spray jet (S1) with the second spray jet (S2) whereby the two fluid spray compositions combine to form a mixture which is capable of polyamide formation and which reacts to form a polyamide and a collision spray fan (F) which is vertically aligned in the gravitational field forms between the spray nozzle arrangement,
d) discharging the polyamide obtained in step c),
e) optionally postpurifying the polyamide discharged in step d),
f) optionally drying the polyamide discharged in step d) and/or postpurified in step e);
wherein the spray nozzle arrangement comprises
at least a first spray nozzle (D1) forming a first spray jet (S1) with a first spray jet cross-sectional area (Q1) and a first spray jet longitudinal extent axis (A1), wherein the first spray jet longitudinal extent axis (A1) is aligned in a gravitational field in a first vertical plane (E1), and a second spray nozzle (D2) forming a second spray jet (S2) with a second spray jet cross-sectional area (Q2) and a second spray jet longitudinal extent axis (A2), wherein the second spray jet longitudinal extent axis (A2) is aligned in a gravitational field in a second vertical plane (E2),
wherein the first spray nozzle (D1) and the second spray nozzle (D2) have a spray direction facing the gravitational field and are arranged relative to each other such that the resultant spray jets (S1, S2) collide in a collision region in the spray direction facing the gravitational field,
wherein the angle (a) between the first spray jet longitudinal extent axis (A1) and the second spray jet longitudinal extent axis (A2) is in the range from 5° to 170°,
and the first spray nozzle (D1) and the second spray nozzle (D2) are arranged such that the first spray jet cross-sectional area (Q1) of the first spray jet (S1) combines with the second spray jet cross-sectional area (Q2) of the second spray jet (S2) to form an intersection set (U) on collision, and
wherein the first and/or second spray jet cross-sectional area (Q1, Q2) is in a range of 15 to 197 000 μm².

17. The method according to claim 16 wherein at least step b) is carried out in the presence of an inert gas.

18. The method according to claim 16 wherein the first and/or the second fluid spray composition comprises at least a lactam selected from ε-caprolactam, 2-piperidone (δ-valerolactam), 2-pyrrolidone (γ-butyrolactam), capryllactam, enantholactam, lauryllactam and mixtures thereof.

19. The method according to claim 16 wherein the first or the second fluid spray composition comprises at least an activator selected from diisocyanates, polyisocyanates, diacyl halides and mixtures thereof.

20. The method according to claim 16 wherein the first or the second fluid spray composition comprises at least a catalyst selected from alkali and alkaline earth metals, in particular from sodium, magnesium, hydrides and reaction products thereof, in particular with lactams.

21. The method according to claim 16 wherein the fluid spray compositions provided in step a) have a viscosity in the range from 1 to 2000 mPa·s, preferably in the range from 1 to 300 mPa·s and most preferably in the range from 2 to 10 mPa·s.

22. The method according to claim 16 wherein the spraying of fluid spray compositions to obtain first and second spray jets (S1, S2) in step b) is effected at a pressure in the range from 2 to 200 bar, preferably in the range from 5 to 100 bar and more preferably in a range from 10 to 50 bar.

23. The method according to claim 16 wherein the polyamide reaction product obtained in step c) has particle sizes in a range of 2 to 500 μm, preferably in the range from 10 to 200 μm, more preferably in the range of 20 to 100 μm.

24. The method according to claim 16 wherein the first spray jet cross-sectional area (Q1) and the second spray jet cross-sectional area (Q2) are not identical and the first spray nozzle (D1) and the second spray nozzle (D2) are arranged such that the first spray jet cross-sectional area (Q1) of the first spray jet (S1) combines with the second spray jet cross-sectional area (Q2) of the second spray jet (S2) to form a subset (T) on collision.

25. The method according to claim 16 wherein the first spray nozzle (D1) and the second spray nozzle (D2) are aligned such that the collision spray fan (F) arranged vertically in the gravitational field following the collision of the first spray jet (S1) with the second spray jet (S2) is arranged in the gravitational field in an angle β in the range from 0 to ½π and π to 3/2π or in the range from ½π to π and 3/2π to 2π between the vertical plane of the collision spray fan (F) and a vertical plane perpendicular to the first and second vertical planes (E1, E2).

26. The method according to claim 16 wherein the first and/or second spray jet cross-sectional area (Q1, Q2) is in a range of 1960 to 50 000 μm².

27. The method according to claim 16 wherein two or more serially arranged spray nozzle arrangements as defined in any preceding claim are used.

28. The method according to claim 16 for a chemical synthesis, comprising the step of colliding the spray jets to form a reaction-capable mixture and to initiate a reaction.

29. The method according to claim 28 for a polymerization, preferably for an anionic lactam polymerization.

30. Use of a polyamide reaction product obtainable by a method according to claim 16 for production of pellets, films, fibers, shaped articles or three-dimensional structures.
